(19) United States
(12) Patent Application Publication
(10) Pub. No.: US 2011/0240324 A1
(43) Pub. Date: Oct. 6, 2011

(54) VIBRATION INSULATING DEVICE FOR A HANDHELD WORK MACHINE

(75) Inventors: Masaki KONDO, Anjo-shi (JP); Shinji YAMAZAKI, Anjo-shi (JP)

(73) Assignee: MAKITA CORPORATION, Anjo-shi (JP)

(21) Appl. No.: 13/045,051

(22) Filed: Mar. 10, 2011

(30) Foreign Application Priority Data
Mar. 31, 2010 (JP) 2010-081578

(51) Int. Cl. B25F 5/00

(52) U.S. Cl. 173/162.2

(57) ABSTRACT

A vibration insulating device connects two members of a handheld work machine via a coil spring. One end of the coil spring is supported by a first supporting member fixed to one member, and the other end is supported by a second supporting member fixed to another member. At least one of the first and second supporting members includes a threaded groove that engages with the coil spring and a tool engaging portion that configured capable of being engaged with a general-purpose tightening tool.

### CROSS-REFERENCE TO RELATED APPLICATION(S)

This application claims priority to Japanese Patent Application No. 2010-81578 filed on Mar. 31, 2010, the contents of which are hereby incorporated by reference into the present application.

### TECHNICAL FIELD

The present application relates to a handheld work machine, and particularly to a vibration insulating device for the handheld work machine.

### DESCRIPTION OF RELATED ART

Japanese Patent Application Publication No. 2001-116074 discloses a vibration insulating device for a handheld work machine. This vibration insulating device is arranged between two members of the handheld work machine. These two members are connected to each other by a coil spring. This type of vibration insulating device is arranged e.g. between a prime mover (e.g., an engine) and a grip grasped by a user, to prevent the transmission of vibrations from the prime mover to the user.

The coil spring of the vibration insulating device is supported by a supporting member fixed to each of the abovementioned members. In other words, one end of the coil spring is supported by a first supporting member fixed to one of the abovementioned members, while the other end of the coil spring is supported by a second supporting member fixed to the other member. Each of these supporting members has a threaded groove extending in a spiral manner so that the supporting members are fixed tightly to the ends of the coil spring by screwing the supporting members into the coil spring.

### BRIEF SUMMARY OF INVENTION

A handheld work machine is often taken apart for maintenance and repair. In so doing, a vibration insulating device also needs to be taken apart, but it is not easy to remove the supporting members from the coil spring as they are screwed into the coil spring. Especially if the handheld work machine has been used for a long time, then the ends of the coil spring are rigidly fixed to the supporting members. In this case, removing the supporting members from the coil spring requires a lot of time and effort.

Accordingly, an object of the present invention is to provide a vibration insulating device for a handheld work machine, in which supporting embers screwed into a coil spring can be removed easily, so as to readily perform maintenance and repairs on the handheld work machine.

A vibration insulating device according to the present invention is provided with a coil spring arranged between two members of a handheld work machine. The coil is configured to connect the two members to each other. A first supporting member is fixed to one of the two members and supports one end of the coil spring. A second supporting member is fixed to another of the two members and supports another end of the coil spring. At least one of the first and second supporting members includes a threaded groove that engages with the coil spring and a tool engaging portion configured capable of being engaged with a general-purpose tightening tool. In addition, it is preferred that the tool engaging portion be formed coaxially with a center axis of the threaded groove (a center axis of a spiral).

In this vibration insulating device, the general-purpose tightening tool can be engaged with the supporting members, and the supporting members can be removed easily from the coil spring by using the tightening tool. Moreover, even when the ends of the coil spring are firmly fixed to the supporting members, the supporting members can be easily removed from the coil spring by applying a large force to the supporting members using the tightening tool. It should be noted that the tightening tool can be used similarly when screwing the supporting members into the coil spring. Therefore, the vibration insulating device can be assembled easily.

According to the vibration insulating device described above, the supporting members can be easily removed from the coil spring by using a standard tightening tool. In addition, adopting this vibration insulating device facilitates the disassembly operation of the handheld work machine, allowing maintenance and repairs to be performed within a relatively short time.

### BRIEF DESCRIPTION OF DRAWINGS

FIG. 1 is a diagram showing a right-hand side (driving side) of an engine-driven cutter of an embodiment.

FIG. 2 is a diagram showing the engine-driven cutter of the embodiment from above.

FIG. 3 is a cross-sectional diagram taken along line of FIG. 1.

FIG. 4 is an exploded perspective view of a vibration insulating device shown in FIG. 3.

FIG. 5 is an exploded perspective view of the vibration insulating device shown in FIG. 3, in which the vibration insulating device is shown from a different angle than FIG. 4.

FIG. 6 is a cross-sectional diagram taken along line VI-VI of FIG. 1

FIG. 7 is an exploded view of the vibration insulating device shown in FIG. 6

FIG. 8 is an exploded perspective view of the vibration insulating device shown in FIG. 6, in which the vibration insulating device is shown from a different angle than FIG. 7.

FIGS. 9A and 9B show a coil spring. FIG. 9A is a plan view of the coil spring shown along an axial direction thereof. FIG. 9B is a cross-sectional diagram taken along line B-B of FIG. 9A.

FIGS. 10A and 10B show a modification of the coil spring. FIG. 10A is a plan view of the coil spring shown along an axial direction thereof. FIG. 1013 is a cross-sectional diagram taken along line B-B of FIG. 10A.

### DETAILED DESCRIPTION OF INVENTION

In one embodiment of the present invention, it is preferred that a tool engaging portion of a supporting member is a columnar-shaped portion that has a side wall on which two parallel surfaces are formed. The columnar-shaped portion preferably is in the shape of e.g., a hexagonal column. The engaging portion with such a structure can be brought into engagement with e.g., a spanner (an open-end wrench), a ring wrench, a box wrench, a monkey wrench, or any other general-purpose tightening tools used for tightening bolts and nuts.

In one embodiment of the present invention, it is preferred that the tool engaging portion of the supporting member is a slot that has a side wall on which two parallel surfaces are formed. The slot preferably is in the shape of e.g., a hexagonal hole. The engaging portion with such a structure can be brought into engagement with e.g., a hexagonal wrench or any other general-purpose tightening tools used for tightening hexagon socket bolts.

In one embodiment of the present invention, it is preferred that the tool engaging portion of the supporting member is a cross-shaped slot or a straight-shaped slot. The engaging portion with such a structure can be brought into engagement with e.g., a Phillips screwdriver, a slotted screwdriver, or any other general-purpose screwdrivers used for tightening screws.

### EMBODIMENT

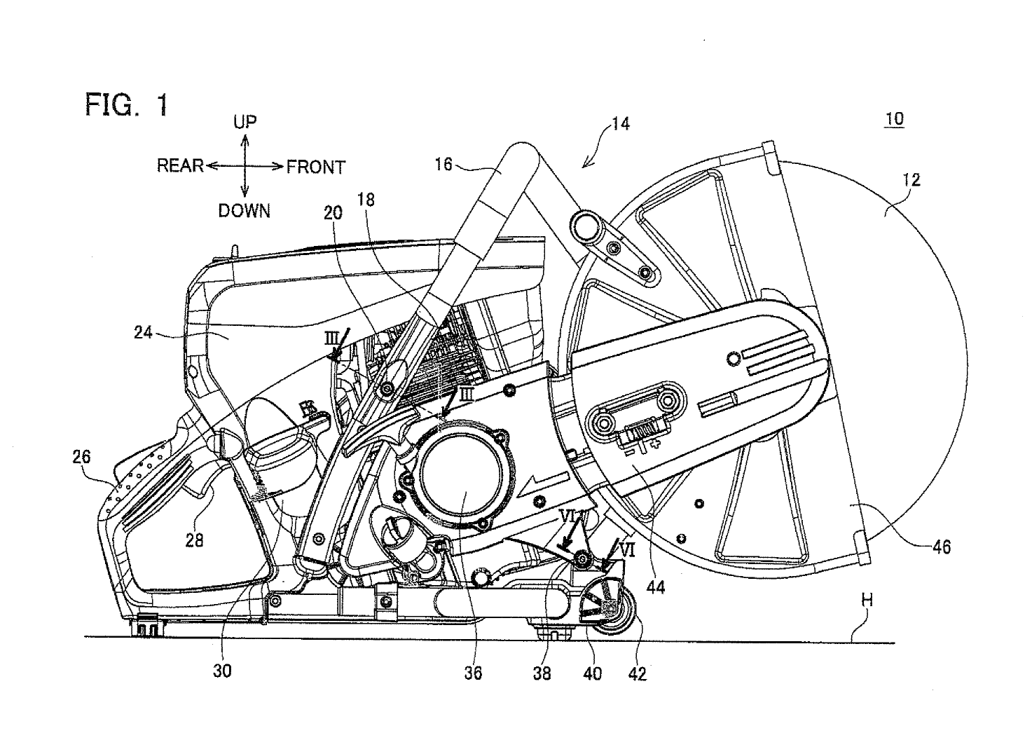

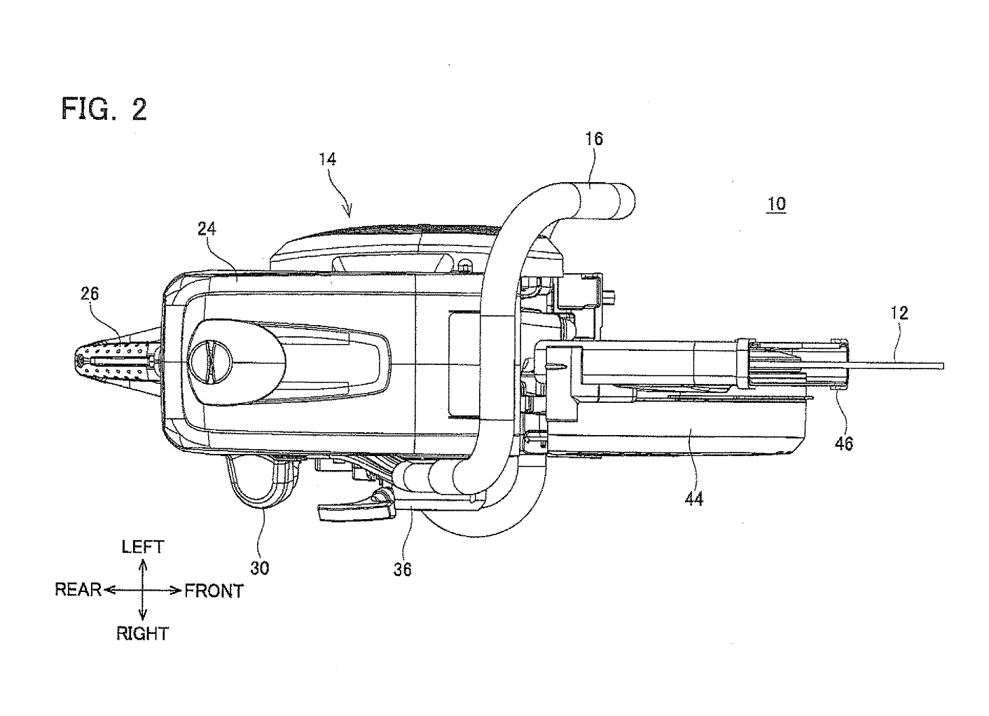

An engine-driven cutter, which is an embodiment of the present invention, is now described with reference to the drawings. FIG. 1 is a side view of an engine-driven cutter 10. FIG. 2 is a plan view of the engine-driven cutter 10. The engine-driven cutter 10 has a disk-shaped rotary blade 12, and a main body 14 for driving the rotary blade 12. The rotary blade 12 is capable of cutting lithic materials and metal materials. Therefore, the engine-driven cutter 10 is used for cutting concrete and steel frames at, e.g., a construction site.

As shown in FIGS. 1 and 2, when the engine-driven cutter 10 is placed on a horizontal plane H, the rotary blade 12 is located on one side in a horizontal direction relative to the main body 14. In the following explanation, on the basis of a state in which the engine-driven cutter 10 is placed on the horizontal plane H, the one side in the horizontal direction in which the rotary blade 12 is located relative to the main body 14 is referred to as “front,” and the side opposite to this one side is referred to as “rear.” In addition, the side upward in a vertical direction is referred to as “up/above,” and the side downward in the vertical direction as “down/below.” As shown in FIG. 2, one side in the horizontal direction perpendicular to a front-rear direction is referred to as “left,” and the other side in the horizontal direction perpendicular to the front-rear direction is referred to as “right.” Thus, the rotary blade 12 is described as “located in front of the main body 14 and having a rotary shaft of the rotary blade 12 extending in a lateral direction.” In other words, the rotary blade 12 is supported vertically with respect to the horizontal plane H, above the horizontal plane H.

The main body 14 is provided with a front handle 16 and a rear grip 26. The front handle 16, formed of a pipe material, is grasped by a user and also functions as a frame for ensuring the strength of the main body 14. The front handle 16 extends from a right side surface of the main body 14 to a lower portion of the main body 14 through above and left of the main body 14. The rear grip 26 is provided in a rear lower portion of the main body 14. The rear grip 26 extends in the form of a loop from the main body 14. The rear grip 26 is provided with an operating switch such as a throttle lever 28.

Normally, the user grasps the front handle 16 with his/her left hand and the rear grip 26 with his/her right hand, to support the engine-driven cutter 10. The user moves the engine-driven cutter 10 relative to a work, and cuts the work with the rotary blade 12. The engine-driven cutter 10 is a handheld engine-driven cutter 10 that is supported by the user in the manner described above. When the user supports the engine-driven cutter 10 in the manner described above, the user positions himself/herself to the left of the main body 14. Since the user normally positions himself/herself to the left of the engine-driven cutter 10, the left side of the engine-driven cutter 10 is also referred to as “user side.”

The main body 14 has an engine 18 for driving the rotary blade 12. This engine 18 is a four-stroke reciprocating engine. The benefits of four-stroke reciprocating engines include lower unburned gas emissions and better fuel efficiency (lower fuel consumption), compared to two-stroke engines. Note that the engine 18 may not only be a four-stroke reciprocating engine but also a two-stroke reciprocating engine or other type of engine.

The main body 14 has a cutter arm 44. The cutter arm 44 is located to the right of the main body 14 and extends toward the front of the main body 14. The cutter arm 44 is fixed to the engine 18. A front end of the cutter arm 44 is provided with the rotary blade 12 and a rotary blade cover 46 covering the rotary blade 12. The cutter arm 44 functions as a transmission mechanism for transmitting a torque, which is output from the engine 18, to the rotary blade 12. The right side of the main body 14 in which the cutter arm 44 functioning as the transmission mechanism is provided is often generally referred to as “driving side.” The cutter arm 44 is further provided with a recoil starter 36. The recoil starter 36 is connected to a drive shaft of the engine 18. The user starts the engine 18 by using the recoil starter 36.

The main body 14 further has a casing 24. The casing 24 is formed of a resin material. The inside of the casing 24 is provided with a filter for filtering air supplied to the engine 18, and a carburetor for mixing the filtered air with fuel. The rear grip 26 mentioned above is integrally formed with the casing 24, and the throttle lever 28 disposed on the rear grip 26 is connected to the carburetor within the casing 24. Additionally, a lower section of the casing 24 functions as a fuel tank and is provided with a fuel supply port 30.

The main body 14 also has a guard 40. The guard 40 is located in a front lower portion of the main body 14. The front lower portion of the main body 14 is where chips of the work scatter from the rotary blade 12. The guard 40 throws the scattering chips of the work back toward a lower section of the main body 14 to prevent the chips of the work from scattering toward the user. The guard 40 is provided with a pair of rollers 42. Here, the guard 40 is fixed to the front handle 16 and attached to the cutter arm 44. In other words, the front handle 16 is attached to the cutter arm 44 fixed to the engine 18, through the guard 40.

When the engine-driven cutter 10 is used, the engine 18, the cutter arm 44 and the rotary blade 12 produce vibrations. Therefore, vibration insulating devices for suppressing the vibrations transmitted to the user are provided in attachment positions where the front handle 16 and the casing 24 integrally formed with the rear grip 26 are respectively attached to the engine 18 and the cutter arm 44. In this embodiment, three types of vibration insulating devices are provided in total at four sections in the engine-driven cutter 10. The structures and functions of two characteristic vibration insulating devices 50, 60 are described hereinafter in detail.

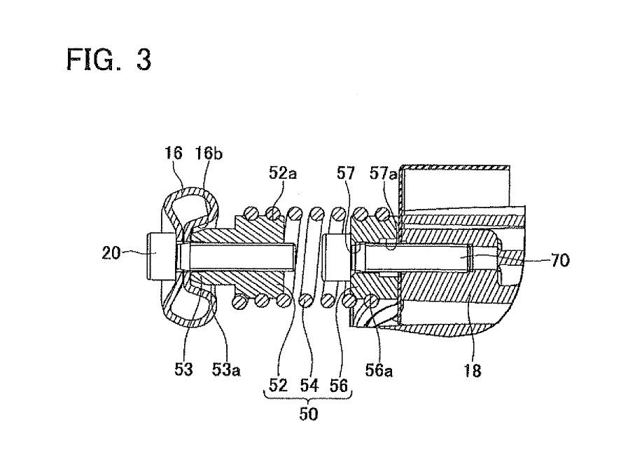

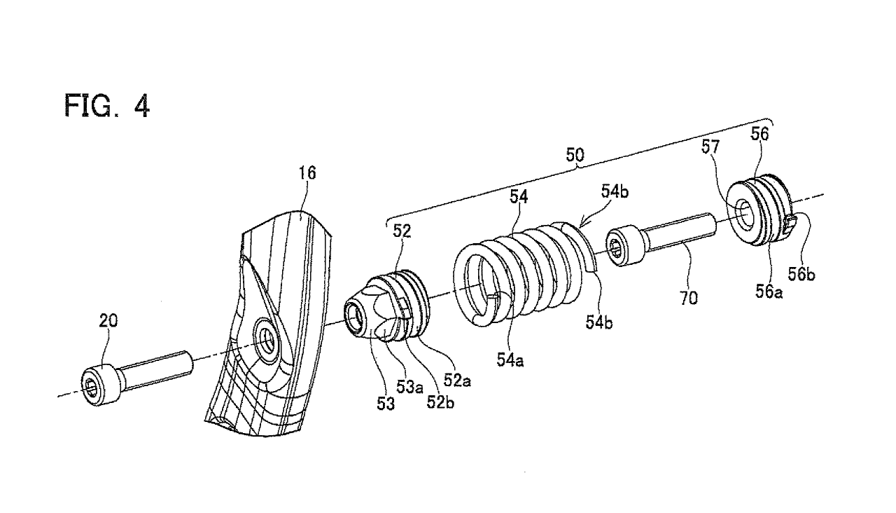

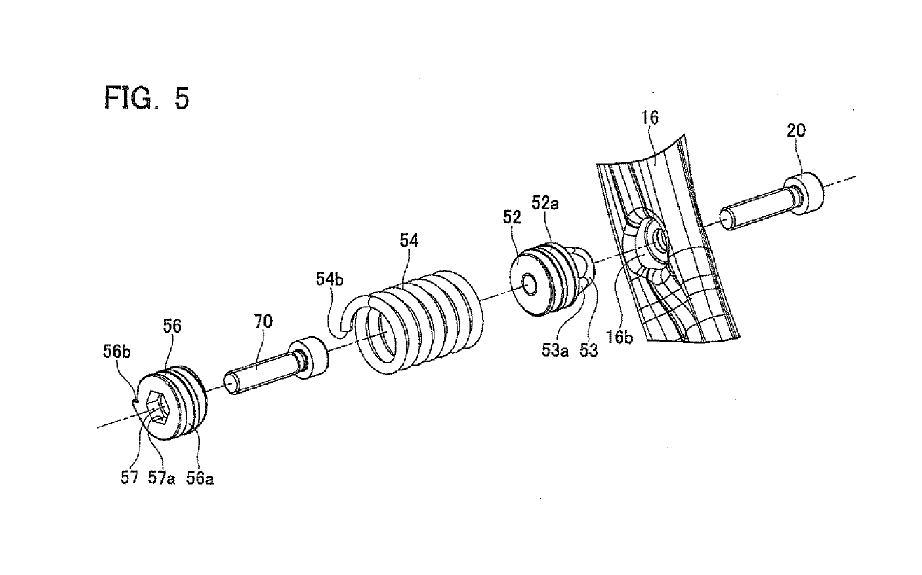

FIG. 3 is a cross-sectional diagram taken along line of FIG. 1, showing a vibration insulating device 50 attached at one of the attachment positions by a bolt 20. FIGS. 4 and 5 are exploded perspective views of the vibration insulating device 50. FIG. 4 is an exploded perspective view showing the right front side of the vibration insulating device 50. FIG. 5 is an exploded perspective view showing the left front side of the vibration insulating device 50.

As shown in FIGS. 3, 4 and 5, the vibration insulating device 50 has a first supporting member 52, a coil spring 54, and a second supporting member 56. The coil spring 54 is arranged between the front handle 16 and the engine 18 to connect the front handle 16 and the engine 18 to each other. Note that the FIGS. 4 and 5 omit the illustration of the engine 18. The transmission of vibration from the engine 18 to the front handle 16 is suppressed by interposing the coil spring 54 between the front handle 16 and the engine 18. As a result, with the vibration being buffered by the coil spring 54, feelings of discomfort and fatigue imposed on the user grasping the front handle 16 can be alleviated.

The coil spring 54 is supported by the first supporting member 52 and the second supporting member 56. The first supporting member 52 supports one end 54a of the coil spring 54 and is fixed to the front handle 16 by the bolt 20. The second supporting member 56, on the other hand, supports another end 54b of the coil spring 54 and is fixed to the engine 18 by a bolt 70. Note that, the one end 54a and the other end 54b of the coil spring 54 herein specifically refer to sectional surfaces of the coil spring 54 at the respective ends. A threaded groove 52a is formed on the first supporting member 52. The threaded groove 52a extends in a spiral manner to engage with the coil spring 54. The first supporting member 52 is securely fixed to the end 54a of the coil spring 54 by being screwed into the coil spring 54, in a manner that spiral of the threaded groove 52a engages with one or more turns of the coil spring 54. Furthermore, a stopper wall 52b that comes into abutment with the end 54a of the coil spring 54 is provided at a terminal position of the threaded groove 52a. The stopper wall 52b protrudes from a circumferential edge of the first supporting member 52. Similarly, a threaded groove 56a and stopper wall 56b are provided in the second supporting member 56, by which a screwed engagement of one or more turns of the coil spring 54 and spiral of the threaded groove 56a and an abutment of the stopper wall 56b and the other end 52b are realized.

The first supporting member 52, in a substantially cylindrical shape, has a projecting portion 53 formed on one of end surfaces of the first supporting member 52. The projecting portion 53 is fitted into a slot 16b provided in the front handle 16, by which the first supporting member 52 is positioned in an appropriate place. As shown in detail in FIG. 4, a tool engaging portion 53a is formed in a part of the projecting portion 53. The tool engaging portion 53a is in the shape of a hexagonal column with a hexagonal cross section and configured to be engaged with a general-purpose tightening tool (e.g., a spanner, a ring wrench, etc.) used for tightening bolts and nuts. The tool engaging portion 53a is provided coaxially with a center axis of the spiral of the threaded groove 52a, so that the first supporting member 52 can be easily screwed into and removed (loosened) from the coil spring 54 by using the general-purpose tightening tool. It should be noted that the shape of the tool engaging portion 53a may not be limited to the hexagonal column; alternatively, any shape with at least two parallel surfaces (so-called bolt width) may be employed.

The second supporting member 56, in a substantially cylindrical shape, has a through-hole 57 formed along a center axis of the second supporting member 56. The through-hole 57 is used for allowing passage of the bolt 70. The bolt 70 passes through the through-hole 57 of the second supporting member 56 and is tightened to the engine 18. As shown in detail in FIG. 5, a tool engaging portion 57a is formed in a part of the through-hole 57. The tool engaging portion 57a is in the shape of a hexagonal hole with a hexagonal cross section and configured to be engaged with a general-purpose tightening tool (e.g., a hexagonal wrench, etc.) used for tightening hexagon socket bolts. The tool engaging portion 57a is provided coaxially with a center axis of the spiral of the threaded groove 56a, so that the second supporting member 56 can be easily screwed into and removed (loosened) from the coil spring 54 by using the general-purpose tightening tool.

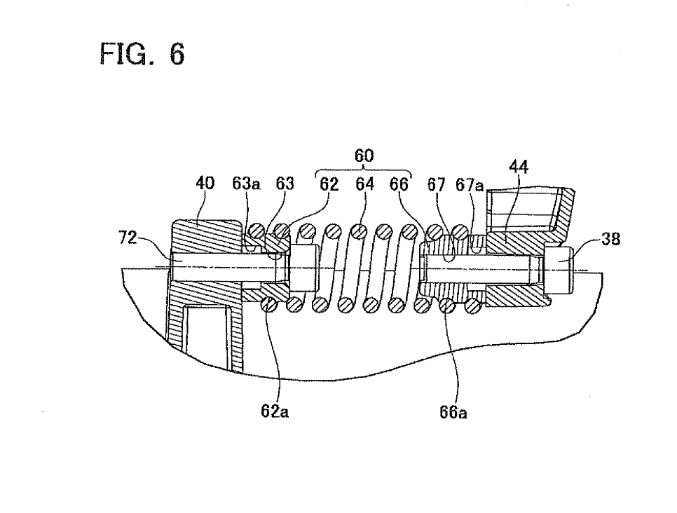

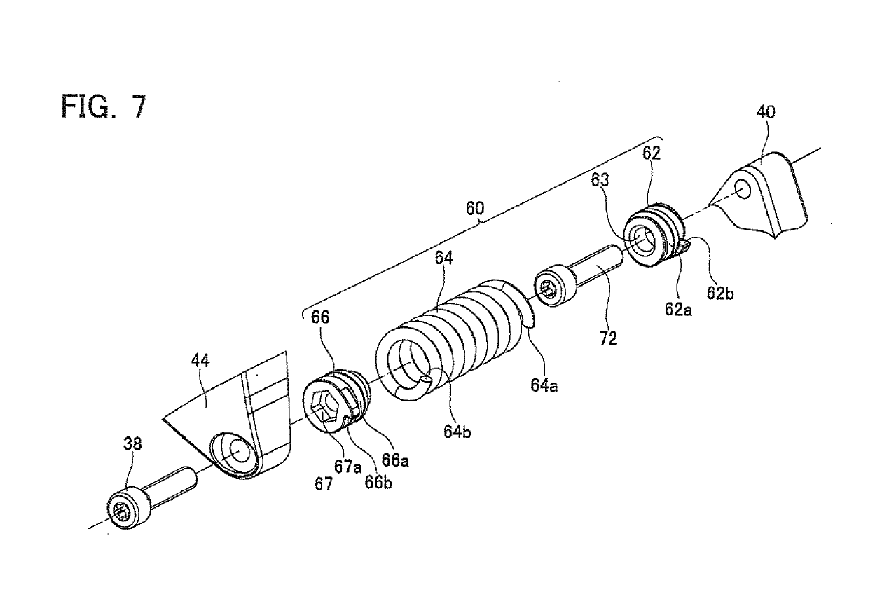

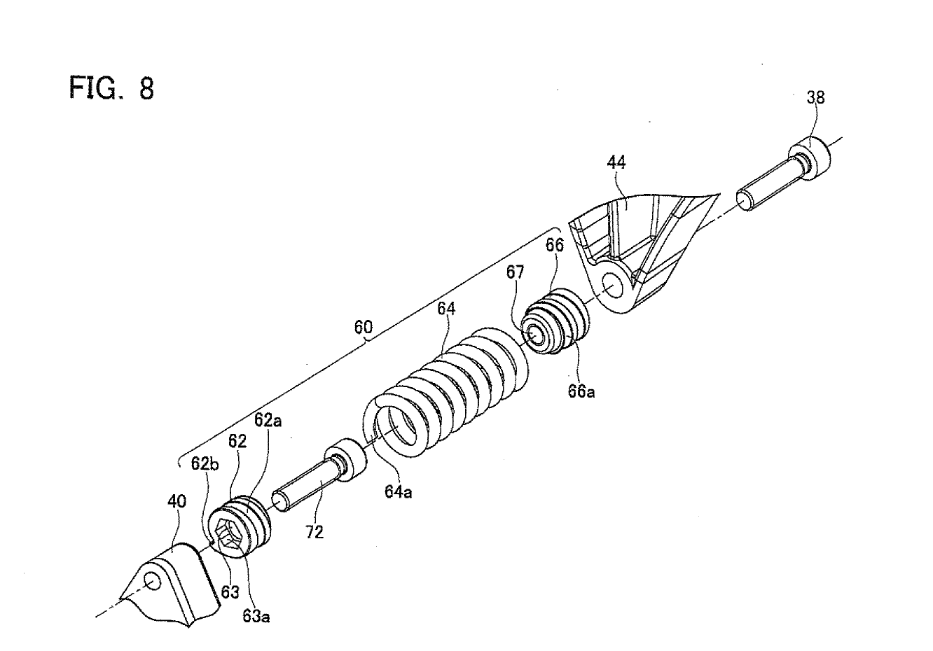

FIG. 6 is a cross-sectional diagram taken along line VI-VI of FIG. 1, showing a vibration insulating device 60 attached to one of the attachment positions by a bolt 38. FIGS. 7 and 8 are exploded perspective views of the vibration insulating device 60. FIG. 7 is an exploded perspective view showing the right front side of the vibration insulating device 60. FIG. 8 is an exploded perspective view showing the left front side of the vibration insulating device 60.

As shown in FIGS. 6, 7 and 8, the vibration insulating device 60 has a first supporting member 62, a coil spring 64, and a second supporting member 66. The coil spring 64 is arranged between the guard 40 fixed to the front handle 16 and the cutter arm 44 fixed to the engine 18, to connect the guard 40 and the cutter arm 44 to each other. The transmission of vibration from the engine 18 to the front handle 16 is suppressed by interposing the coil spring 64 between the guard 40 fixed to the front handle 16 and the cutter arm 44 fixed to the engine 18. As a result, with the vibration being buffered by the coil spring 64, feelings of discomfort and fatigue imposed on the user grasping the front handle 16 can be alleviated.

The coil spring 64 is supported by the first supporting member 62 and the second supporting member 66. The first supporting member 62 supports one end 64a of the coil spring 64 and is fixed to the guard 40 by a bolt 72. The second supporting member 66, on the other hand, supports another end 64b of the coil spring 64 and is fixed to the cutter arm 44 by the bolt 38. Note that, the one end 64a and the other end 64b of the coil spring 64 herein specifically refer to sectional surfaces of the coil spring 64 at the respective ends. A threaded groove 62a is formed on the first supporting member 62. The threaded groove 62a extends in a spiral manner to engage with the coil spring 64. The first supporting member 62 is securely fixed to the end 64a of the coil spring 64 by being screwed into the coil spring 64, in a manner that spiral of the threaded groove 62a engages with one or more turns of the coil spring 64. Furthermore, a stopper wall 62b that comes into abutment with the end 64a of the coil spring 64 is provided at a terminal position of the threaded groove 62a. The stopper wall 62b protrudes from a circumferential edge of the first supporting member 62. Similarly, a threaded groove 66a and stopper wall 66b are provided in the second supporting member 66, by which a screwed engagement of one or more turns of the coil spring 64 and spiral of the threaded groove 66a and an abutment of the stopper wall 66b and the other end 62b are realized.

The first supporting member 62, in a substantially cylindrical shape, has a through-hole 63 formed along a center axis of the first supporting member 62. The through-hole 63 is used for allowing passage of the bolt 72. The bolt 72 passes through the through-hole 63 of the first supporting member 62 and is tightened to the guard 40. As shown in detail in FIG. 8, a tool engaging portion 63a is formed in a part of the through-hole 63. The tool engaging portion 63a is in the shape of a hexagonal hole with a hexagonal cross section and configured to be engaged with a general-purpose tightening tool (e.g., a hexagonal wrench, etc.) used for tightening hexagon socket bolts. The tool engaging portion 63a is provided coaxially with a center axis of the spiral of the threaded groove 62a, so that the first supporting member 62 can be easily screwed into and removed (loosened) from the coil spring 64 by using the general-purpose tightening tool.

The second supporting member 66, in a substantially cylindrical shape, has a through-hole 67 formed along a center axis of the second supporting member 66. The through-hole 67 is a screw hole into which the bolt 38 is screwed. The bolt 38 clips the cutter arm 44 and is tightened to the second supporting member 66. As shown in detail in FIG. 7, a tool engaging portion 67a is formed in a part of the through-hole 67. The tool engaging portion 67a is in the shape of a hexagonal hole with a hexagonal cross section and configured to be engaged with a general-purpose tightening tool (e.g., a hexagonal wrench, etc.) used for tightening hexagon socket bolts. The tool engaging portion 67a is provided coaxially with a center axis of the spiral of the threaded groove 66a, so that the second supporting member 66 can be easily screwed into and removed (loosened) from the coil spring 64 by using the general-purpose tightening tool.

As described above, in the vibration insulating devices 50, 60 of the present embodiment, the user can use the general-purpose tightening tools to remove the supporting members 52, 56, 62, 66 from the coil springs 54, 64. Therefore, even when the ends of the coil springs 54, 64 are firmly fixed to the supporting members 52, 56, 62, 66, large forces can be applied to the supporting members 52, 56, 62, 66 by the tightening tools. In this manner, the supporting members 52, 56, 62, 66 can be easily removed from the coil springs 54, 64. Also when screwing the supporting members 52, 56, 62, 66 into the coil springs 54, 64, the tightening tools can be used similarly. Therefore, the vibration insulating devices 50, 60 can be assembled easily. Thus, the user can readily perform repairs and maintenance on the engine-driven cutter 10 within a relatively short time.

Next is described a specific example of removing the supporting members 52, 56, 62, 66 from the coil spring 54, 64 upon the repairs and maintenance on the engine-driven cutter 10. First, in the vibration insulating devices 50, 60, the coil springs 54, 64 and the supporting members 52, 56, 62, 66 might be damaged as a result of being subjected to large forces and strong vibrations during use. In this case, the supporting members 52, 56, 62, 66 need to be removed from the coil springs 54, 64 in order to replace the damaged coil springs 54, 64 or the supporting members 52, 56, 62, 66. The user can use the tightening tools described above, to easily remove the supporting members 52, 56, 62, 66 from the coil springs 54, 64.

In the engine-driven cutter 10, on the other hand, a failure might occur in the engine 18, in which case the vibration insulating devices 50, 60 needs to be disassembled in order to repair the broken engine 18. For example, as shown in FIG. 3, the user needs to remove the bolt 20 first, in order to remove the engine 18 from the engine-driven cutter 10. The user then needs to remove the vibration insulating device 50 from the engine 18 so that the vibration insulating device 50 is not in the way of repairing the engine 18. When removing the vibration insulating device 50 from the engine 18, normally the user can simply rotate the coil spring 54 with respect to the second supporting member 56 and thus can remove the coil spring 54 and the first supporting member 52 from the engine 18. Thereafter, the user may remove the bolt 70 and the second supporting member 56 from the engine 18 according to need.

However, e.g. in the engine-driven cutter 10 that has been used for a long time, the end of the coil spring 54 might be strongly, firmly fixed to the second supporting member 56. In this case, the coil spring 54 cannot be removed from the engine 18 in the manner described above. In order to remove the vibration insulating device 50 from the engine 18, first, the first supporting member 52 needs to be removed from the coil spring 54, and then the bolt 70 fixing the second supporting member 56 to the engine 18 needs to be removed. In most cases the end of the coil spring 54 is firmly fixed to the first supporting member 52, as with the case of the second supporting member 56. However, the user can use the tightening tools to easily remove the first supporting member 52 from the coil spring 54. Removing the first supporting member 52 allows easy removal of the bolt 70 fixing the second supporting member 56, even when the coil spring 54 is attached. Or, in other cases, when the first supporting member 52 is rotated using the tightening tool, the first supporting member 52 may rotate along with the coil spring 54, by which the coil spring 54 may be removed from the second supporting member 56. In either case, the vibration insulating device 50 can be easily removed from the engine 18 by using the tightening tool. Furthermore, not only when repairing the engine 18 but also when performing maintenance such as overhaul on the engine 18, the engine 18 is removed from the engine-driven cutter 10, and then the vibration insulating devices 50, 60 may further be removed from the engine 18.

When disassembling and assembling the vibration insulating devices 50, 60 described above, the general-purpose tightening tools can be used on the vibration insulating devices 50, 60, in place of special tools. Since hexagonal wrenches, spanners and other general-purpose tightening tools are widely distributed, the user can easily obtain tightening tools that can be used for disassembling and assembling the vibration insulating devices 50, 60. Most users might already possess such general-purpose tightening tools as hexagonal wrenches and spanners. These users can save unnecessary expense because they do not need to prepare a new, special tightening tool for disassembling or assembling the vibration insulating devices 50, 60. These users include not only owners and users of the engine-driven cutter 10 but also those involved in repairing the engine-driven cutter 10.

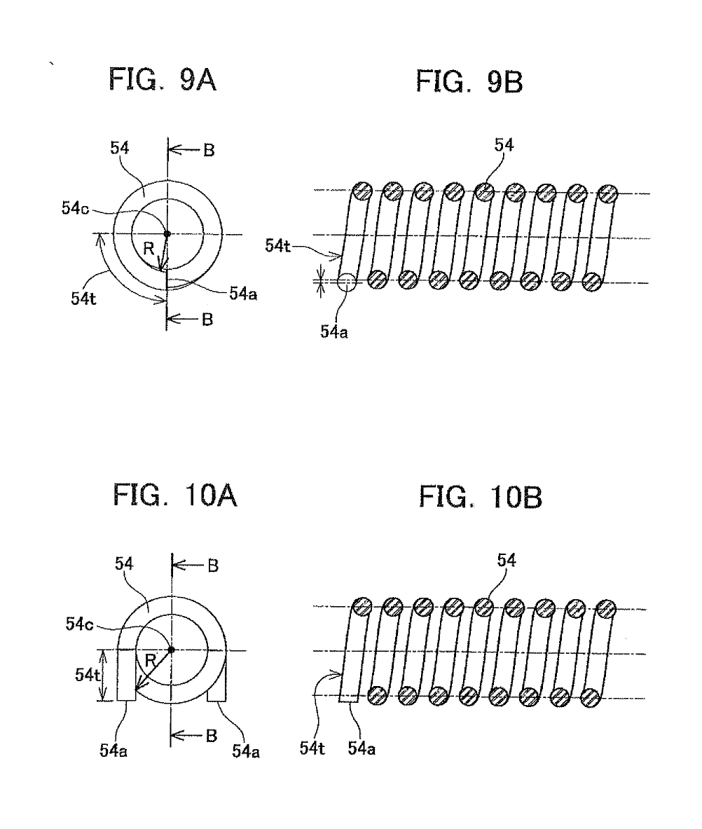

FIGS. 9A and 9B show the coil spring 54 shown in FIGS. 3, 4 and 5. FIG. 9A is a plan view of the coil spring 54 shown along an axial direction thereof. FIG. 98 is a cross-sectional diagram taken along line B-B of FIG. 9A. As shown in FIG. 9, a curvature radius R of an end portion 54t of the coil spring 54 (more specifically, a quarter of a turn including the end 54a) gradually becomes large toward the end 54a. With this structure, the first supporting member 52 can be easily screwed into the coil spring 54. The other end portion of the coil spring 54 (more specifically, a quarter of the turn including the end 54b) is provided with a similar structure, in which the second supporting member 56 can also be easily screwed into the coil spring 54.

Although not shown, each end portion of the coil spring 64 shown in FIGS. 6, 7 and 8 also has the same structure as the end 54t of the coil spring 54 shown in FIG. 9, with different length, winding diameter, and the like.

FIGS. 10A and 10B show a modification of the coil spring 54. In this coil spring 54, an end portion 54t thereof extends linearly along a tangential direction. Therefore, a distance R from a center axis 54c (this distance R corresponds to the curvature radius R) gradually becomes large toward each end 54a, 54b. With such a configuration of this end portion as well, each of the supporting members 52, 56 can be easily screwed into the coil spring 54.

Specific embodiment of the present teachings is described above, but this merely illustrates some representative possibilities for utilizing the teachings and does not restrict the claims thereof. The subject matter set forth in the claims includes variations and modifications of the specific examples set forth above.

For example, the shapes of the tool engaging portions 53a, 57a, 63a, 67a that are formed in the supporting members 52, 56, 62, 66, respectively, are not limited to the shapes described above and can be changed to any other shapes that allow engagement with the general-purpose tightening tools. For instance, the tool engaging portions 53a, 57a, 63a, 67a can be shaped into cross-shaped slots or straight-shaped slots. Phillips screwdriver, slotted screwdrivers, or any other general-purpose screwdrivers used for tightening screws can be engaged with these slots.

The vibration insulating devices 50, 60 described in the present embodiment can be adopted not only in engine-driven cutters but also in other types of handheld work machines such as chainsaws and hedge trimmers. Such handheld work machines may be not only the handheld work machines having engines as prime movers, but also the electric handheld work machines having motors as prime movers.

What is claimed is:

1. A vibration insulating device for a handheld work machine, the vibration insulating device comprising:
a coil spring arranged between two members of the handheld work machine, and connecting the two members to each other;
a first supporting member fixed to one of the two members, and supporting one end of the coil spring; and
a second supporting member fixed to another of the two members, and supporting another end of the coil spring,
wherein at least one of the first and second supporting members includes a threaded groove that engages with the coil spring and a tool engaging portion configured capable of being engaged with a general-purpose tightening tool.

2. A vibration insulating device as in claim 1, wherein the tool engaging portion is formed coaxially with a center axis of a spiral of the threaded groove.

3. A vibration insulating device as in claim 1, wherein the tool engaging portion comprises a columnar-shaped portion configured capable of being engaged with the general-purpose tightening tool.

4. A vibration insulating device as in claim 3, wherein the columnar-shaped portion comprises a side wall on which two parallel surfaces are formed.

5. A vibration insulating device as in claim 4, wherein the columnar-shaped portion has a shape of a hexagonal column.

6. A vibration insulating device as in claim 1, wherein the tool engaging portion comprises a hole configured capable of being engaged with the general-purpose tightening tool.

7. A vibration insulating device as in claim 6, wherein the hole has a shape of a hexagonal hole.

8. A vibration insulating device as in claim 1, wherein the tool engaging portion comprises a cross-shaped slot configured capable of being engaged with a cross slot screwdriver.

9. A vibration insulating device as in claim 1, wherein the tool engaging portion comprises a straight-shaped slot configured capable of being engaged with a straight slot screwdriver.

10. A handheld work machine comprising at least one vibration insulating device as in claim 1.

11. A handheld work machine as in claim 10, further comprising at least one handle grasped by a user, wherein the at least one handle is supported by the at least one vibration insulating device.
